(19) United States
(12) Patent Application Publication
(10) Pub. No.: US 2015/0138085 A1
(43) Pub. Date: May 21, 2015

(54) Electronic apparatus for simulating or interfacing a backward compatible human input device by means or control of a gesture recognition system

(71) Applicants: Bradley Lloyd Wilk, Pacific Grove, CA (US); Eric John Dluhos, Mifflinburg, PA (US)

(72) Inventors: Bradley Lloyd Wilk, Pacific Grove, CA (US); Eric John Dluhos, Mifflinburg, PA (US)

(21) Appl. No.: 14/121,112

(22) Filed: Jul. 31, 2014

Related U.S. Application Data
(60) Provisional application No. 61/958,603, filed on Jul. 31, 2013.

(51) Int. Cl. G06F 13/10; G06F 3/01; G06F 3/041; G06F 3/038; G06F 3/023; G06F 3/0354

(52) U.S. Cl. CPC G06F 13/105; G06F 3/0233; G06F 3/03543; G06F 3/041; G06F 3/0416; G06F 3/038; G06F 3/017
USPC 345/158

(57) ABSTRACT

Method and apparatus where human gestures are interpreted by means of software running on a host computer, into screen coordinates and low level commands—keyboard presses, clicks, double-clicks, drag-and-drop, wheel scroll etc.—which are sent to a hardware peripheral, instead of a software based Application Programming Interface, which hardware corrects and polishes the said screen coordinates and low level commands and translates said data by means of emulating, simulating or manipulating the protocol of an actual Human Input Device (HID)—such as a standard keyboard, mouse, joystick, touchpad, etc.—which actual HID-compliant device or simuloid is embedded into the invention, proper, and is in turn connected back into the host computer where it's recognized by native drivers as a standard HID device so that it may interact with common end-user programs in the usual manner—but thus be controlled by means of human gestures.

### CROSS REFERENCE

This application claims priority from U.S Provisional Application 61/958,603 filed Jul. 31, 2013 and is fully incorporated herein in its entirety for all purposes.

### FEDERAL RESEARCH

Not applicable

### BRIEF DESCRIPTION OF THE INVENTION

The invention solves hard to address anomalies such as unexpected glitches, speed delays, system crashes and the like, as well as other qualitative issues that gesture recognition software, or even automated user-interface programs such as macro shortcut drivers, relying primarily upon a software-only based API (Application Programming Interface) that would emulate, simulate or manipulate the presence of a Human Input Device (HID)—such as a standard keyboard, mouse, joystick, touchpad or any other related peripheral of the genre—would encounter when the said gesture recognition software or macro shortcut driver controlling said HID peripheral by reason of said software-only based API which in turn emulates, simulates, or manipulates the presence of said HID peripheral is used to interface and thus interact with other end-user software applications—games, word processors, spreadsheets and the like—which run simultaneously on the same, general purpose, host computer.

The invention has four inter-related main advantages over the prior art:

(1) By using dedicated hardware as part of its solution the invention avoids the pitfalls of speed delay and unreliable operation which are known to plague OOP (Object-Oriented Programming) based software APIs in general. APIs act as intermediary conduits of communication between different software platforms, or between software platforms and hardware platforms. Software-only APIs which act as complete interface solutions are good for handling some tasks, but not others and most especially not in situations where complex analysis is introduced on either side of that interface—analysis such as can be found in a gesture recognition system. The said gesture recognition system can introduce speed delay and other anomalous effects which would be amplified by orders of magnitude by a software API, which API rather continuously polls for command sequences as input and requires processor and memory resources to effectuate an output, all the while in a manner subject to limitations of either time sharing and/or other operating system-controlled, priority based handling routines, and/or processor-based interrupt vector servicing of more important tasks. This is because software APIs, like any other piece of software, are thread limited in functionality, and this resource dedication limitation is either set in cement, hampered greater or worse, by programming, or is in flux completely at the whim of the operating system, or is in flux by reason of the present state of the Central Processing Unit (CPU) which is handling other tasks concurrently. As a consequence, the behavior of an API is completely unpredictable to be said at best. Noticeable anomalous effects can occur including speed delays, errors and even system crashes depending on wrong or unsuitable combinations of events which affect the overall system resources at any given time. It is known to those skilled in the art that in the modern computing industry, software-only based APIs are more-often-than not created to replicate or simulate functionality, using software-only means, that which is generally accorded to and performed best by using dedicated hardware solutions. This unfortunate practice tends to diminish performance in many systems.

(2) The invention is completely backward compatible and thus allows practically all pre-existing end-user application software—programs such as games, spreadsheet, word-processing, and Internet browsing software and the like—to be controlled by human gestures by channeling complex recognition of said gestures through a hardware-only-based portal that translates raw data coordinates and other commands into the actual protocols that are used by standard, backward compatible, ubiquitously available and ubiquitously native-driver-system-recognized Human Input Devices (HID) such as a standard keyboard and/or standard mouse, and so forth. That is, by means of the invention the said HID is controlled by human input indirectly through means of an intermediary front end entity such as a gesture recognition program which performs the hardest work by capturing and recognizing gesture-based actions of the human user which in turn are translated to standard HID-based data packet sets, which data packet sets are communicated to and from the host computer using standard HID-protocol-compliant based communication signals. In other words, the gesture recognition program as a self-contained piece of software running on the host computer handles the brunt force of recognizing commands given by the human user by means of hand signals, hand waves, and other gestures, translating these into a simple set of data which include screen coordinates and other commands, and sends this said data to a hardware-based peripheral—the invention proper—rather than to an onboard software-based API for further processing. The hardware-based peripheral part of the invention then polishes, enhances or otherwise filters the data by removing gaps in coordinates, missing command or key-press sequences, and in so doing finally translates these elements into HID-protocol-compliant communication signals common to one or more standard HID peripherals which the operating system of the host computer will natively recognize and engage in communications with, and through means of which any end-user application programs running on the same host computer may automatically be controlled and manipulated thereby, but hence by gestures.

(3) The invention is completely independent of any forced modifications that a software-based API (Application Programming Interface) or any one available gesture recognition program created by the operating system designer or a third party software vendor may impose on end-user application programs running on the same host machine as a prerequisite to their operational compatibility. It is known to those skilled in the art that the general practice of using software based APIs with end-user application programs requires time, skill, and monetary expense for individuals to learn an new SDK (Software Development Kit) so that applications can be modified to include an API's functionality. It is a stringent and highly costly practice requiring that end-user application programs must be redesigned and recompiled with embedded procedure calls to the API. Every time an API or SDK is updated or modified with significant changes by the operating system designer or by a third party software developer, application software accordingly requires a total redesign and recompile, adding that this practice is what implicitly makes it generally impossible for any new software-based API to add any new functionality to pre-existing software applications. Here, the invention is highly unique. Moreover, the troubles associated with software APIs are greatly amplified where intellectual property concerns or designer ego factor into the overall quality of the functionality that can be attained by any given software API. This is because some API are crafted specifically as work around to systems that would certainly have better functionality in certain respects or aspects if, simply put, the conflicts of interests of some parties to avoid paying toll costs to either “patent trolls” or royalties to respectable rights owners, were not an issue. By implementing fully backward compatible protocols, the invention is not subject to any of these drawbacks.

(4) The invention saves against the high cost of external brunt force stand-alone hardware—or externally encapsulated brunt force hardware and software combined—that would be required as the means to run a complex gesture recognition program. For this part of the invention it takes advantage of the available memory and the available processing power that the general purpose host computer, simultaneously running said other common end-user application programs, will have left to give to it in terms of the overall surplus reserves remaining. The preferred embodiment is that the gesture recognition algorithms be handled by the general purpose computer which hosts the invention, but an alternative embodiment would include additional external software, at a higher cost to the consumer, of course, which could handle these functions in similar outboard-style manner, which connects into the invention directly.

### BRIEF DESCRIPTION OF THE DRAWINGS

FIG. 01 shows the overall design of the invention. 100 is a general purpose host computer. 101 is the invention connected to the computer. 102 is a common peripheral input/output ports which supplies commands and other data to the invention. 103 is a similar port which communicates with the invention and by which HID-protocol-compliant signals make their way into the host computer from the invention. 104 and 105 are bypass input ports into which HID peripherals such as a standard keyboard and a mouse are connected into the invention for direct user input. 106 is a camera connected to the host computer through another input/output port.

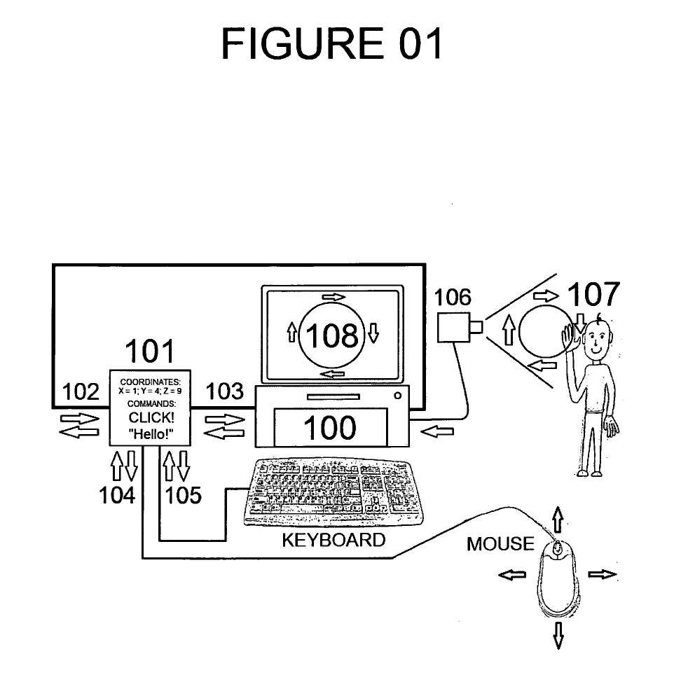

107 is a human user providing gesture signals to the camera of which it is to be understood that the host computer is recognizing, and which the invention is translating into HID protocols, the results of which are seen on the systems display monitor screen, 108.

### DETAILED DESCRIPTION OF THE INVENTION

Gestures, which include analog movements and analog commands and other performances of a real or virtual subject in a real world or virtual environment, respectively, are captured by means of a camera or other sensor apparatus, real or virtual, and are presented by means of a suitable interface to a front end processing device, a computer employing a central processor, memory, secondary storage media and software, or some other form of electronic or electromechanical apparatus containing stored procedures, where they are first stored as raw sensory data and then processed by means of a plurality of filters and/or interpretation or translation algorithms, the intermediate output result of which is a plurality of two dimensional X, Y and/or Z movement coordinates; keyboard keystroke commands; and/or joystick directional commands; and/or mouse button click, double-click and wheel-scroll commands, in the form of digital codes, or other electronic signals presented as ongoing feed-forward output, or stored in an accessible table, array, queue, stack or other data structure. These said outputs are the final processed interpretations of the said front end apparatus which is employed for its raw analysis purposes to decode or otherwise interpret the said input gestures so as to attain the said coordinates and commands which coordinates and commands being similar in terms of value to those normally gathered by an actual HID-compliant device such as a joystick, mouse, keyboard, etc.

The methods and techniques by which the applied gestures are interpreted, filtered or otherwise translated or converted into said output coordinates and/or said output commands are indigenous to the particular gesture recognition system being employed at the time of conversion to produce said coordinates and command outputs, and the invention does not limit itself as to any specific gesture recognition method which may be employed by a person or persons skilled in the art for this purpose of producing these said intermediary outputs of coordinates and/or commands, with no claim being made here as to any specific algorithm of gesture recognition.

The said analog movements and analog commands of said input gestures, therefore, having thus been translated into resulting digital interpretation as the resulting said digital codes, data or other electronic signals, represented as digital coordinates and commands, respectively, collected by the gesture recognition apparatus, may be stored temporarily into a buffer, a memory storage device such as RAM or other electronic or electromechanical device to hold the said co-ordinates and/or commands prior to utilization for some end-user purpose and end-user application making use of them. Said buffer or memory storage device is configured containing one or more suitable data structures for this purpose of utilization. Said data structures include tables, arrays, queues, stacks, and data structures invoking an API—Application Programming Interface—amongst others.

The said coordinates and/or commands are then applied by the invention for use by end-user devices and end-user applications as follows. The output coordinates and/or output commands temporarily stored into said buffer on the gesture recognition side of the system are first collected from the said storage buffer, accessed by means of a hardware and or software interface which is algorithmically designed specifically to communicate with the indigenous access protocols of the said buffer so as to facilitate the collection of the said coordinates and commands.

The invention proper, having captured said coordinates and/or commands, transfers the said coordinates and/or commands into its own memory unit buffer, structures as an arrays, queues, stacks, amongst others. The invention then processes the said captured coordinates and/or commands, employing any of a wide variety of conventional filtering methods, or those which may be envisioned, to ultimately polish or otherwise refine in some manner the raw state of the coordinates to make them more presentable. Such filters may include curve re-shaping and/or smoothing algorithms and techniques, amongst others.

The said coordinates and/or commands, either polished as described, or raw as captured directly from the gesture recognition system by means of said capture interface, are then fed by the invention to an inclusive hardware based or software based emulator which invokes one or more HID (Human Input Device) compliant device interfaces—joystick, mouse, keyboard etc.—so as to enter into communication with resident drivers of an end-user device—a personal computer or mobile computing device, for example, running end-user application software.

Thus, the final result is that the said coordinates and/or commands are captured by the invention, processed by the invention, and presented by the invention to the end-user device and end-user application in a manner that said end-user device and end-user application has no understanding that said coordinates and/or commands are ultimately being controlled more purely by gestures rather than by means of HID-compliant devices.

For all practical purposes the end-user device and the end-user application thinks it is communicating with low level HID-compliant devices, and not a higher level gesture recognition technology. No modifications or adaptations, therefore, need to be made to the end-user devices and end-user applications in order for said end-user devices and end-user applications to be upgraded to interact with and make use of control inputs by means of said gestures. In the preferred embodiment, the IBM PS2 protocols are employed in the HID-emulator methods, but many other protocols may be used.

The invention is completely backward compatible and thus allows practically all pre-existing end-user application software—programs such as games, spreadsheet, word-processing, and Internet browsing software and the like—to be controlled by human gestures by channeling complex recognition of said gestures through a hardware-only-based portal that translates raw data coordinates and other commands into the actual protocols that are used by standard, backward compatible, ubiquitously available and ubiquitously native-driver-system-recognized Human Input Devices (HID) such as a standard keyboard and/or standard mouse, and so forth.

That is, by means of the invention the said HID is controlled by human input indirectly through means of an intermediary front end entity such as a gesture recognition program which performs the hardest work by capturing and recognizing gesture-based actions of the human user which in turn are translated to standard HID-based data packet sets, which data packet sets are communicated to and from the host computer using standard HID-protocol-compliant based communication signals. In other words, the gesture recognition program, as a self-contained piece of software running on the host computer, handles the brunt force of recognizing commands given by the human user by means of hand signals, hand waves, and other gestures, translating these into a simple set of data which include screen coordinates and other commands, and sends this said data to a hardware-based peripheral—the invention proper—rather than to an onboard software-based API for further processing.

The hardware-based peripheral part of the invention then polishes, enhances or otherwise filters the data by removing gaps in coordinates, missing command or key-press sequences, and in so doing finally translates these elements into HID-protocol-compliant communication signals common to one or more standard HID peripherals which the operating system of the host computer will natively recognize and engage in communications with, and through means of which any end-user application programs running on the same host computer may automatically be controlled and manipulated thereby, but hence by gestures.

The invention is completely independent of any forced modifications that a software-based API (Application Programming Interface) or any one available gesture recognition program created by the operating system designer or a third party software vendor may impose on end-user application programs running on the same host machine as a prerequisite to their operational compatibility. It is known to those skilled in the art that the general practice of using software based APIs with end-user application programs requires time, skill, and monetary expense for individuals to learn an new SDK (Software Development Kit) so that applications can be modified to include an API's functionality. It is a stringent and highly costly practice requiring that end-user application programs must be redesigned and recompiled with embedded procedure calls to the API. Every time an API or SDK is updated or modified with significant changes by the operating system designer or by a third party software developer, application software accordingly requires a total redesign and recompile, adding that this practice is what implicitly makes it generally impossible for any new software-based API to add any new functionality to pre-existing software applications. Here, the invention is highly unique. By implementing fully backward compatible protocols, the invention is not subject to any of these drawbacks.

The invention saves against the high cost of external brunt force stand-alone hardware—or externally encapsulated brunt force hardware and software combined—that would be required as the means to run a complex gesture recognition program. For this part of the invention it takes advantage of the available memory and the available processing power that the general purpose host computer, simultaneously running said other common end-user application programs, will have left to give to it in terms of the overall surplus reserves remaining. The preferred embodiment is that the gesture recognition algorithms be handled by the general purpose computer which hosts the invention, but an alternative embodiment would include additional external software, at a higher cost to the consumer, of course, which could handle these functions in similar outboard-style manner, which connects into the invention directly.

The invention ensures a WYSIWYG (What You See Is What You Get) accuracy that if the gesture recognition program is doing at least a very large percentage of what it is supposed to be doing—not necessarily all of what it is supposed to be doing—the emulated keyboard and/or mouse will provide the correct result to the host computer in terms of at minimum glitch free operation that ubiquitously have come to be expected by these quite reliable, standard HID devices.

The invention also includes bypass ports so that an actual keyboard and/or mouse peripheral etc. can be plugged directly into the invention for the purpose of merging or superimposing these additional signals with its own gesture-implied-and-translated signals so that an end user can resort back to using the standard HID peripherals at any moment in time, in an unfettered manner, and so that no additional ports on the host computer need to be consumed for the extra original devices.

Moreover, the invention may carry embedded intelligence such that some of the commands that it might wish to invoke on its own volition in terms of HID-compliant actions such as keyboard button presses, mouse clicks, drags-and-drops, and wheels scrolls. Said actions thus might be improvised by the device in response to a more versatile understanding of a variety of collectives of gestures or sequences of gestures, or even sign language, even if they be counter-intuitive to conventional gesture styles associated with a click, double-click or wheel scroll in so forth performed in gesture space. Similarly, rather than stringently depending on a stringent flow of raw joystick or mouse move-type coordinates coming to it from the gesture recognition program—a data flow which have gaps in it as a result of potential gesture recognition glitches that might be expected to occur by means of known qualitative issues generally associated with gesture recognition software programs of recent and current genre which may encounter bugs or glitches in its own internal recognition schemes, such gaps in data might be filtered smooth or otherwise corrected to maintain a follow-through smooth manner of unbroken end result trace movements.

Additionally, said coordinates which are part of a gesture which invokes a specific mouse action command but which also imply a viable change in mouse coordinates based on the mere movement of the action-command invoking gesture itself, may provide the end result of an undesirable application screen-manifested artifact. Such an artifact—a brief tit-like entity or sharp burr for instance—would be enough to make a gesture controlled cursor position presently hovering on a specific location on a GUI-screen, perhaps directly over a button that is next meant to be clicked as the next action, annoyingly jump off the selected button simply because the following gesture that is needed to invoke the click also simultaneously implies a mouse move. For this situation, and for various related situations like this, the hardware peripheral of invention is granted innate the requisite pre-emptive power to importantly delay or completely prevent the forwarding of certain mouse move coordinates to reach the host machine before action translations can be acquired. Part of the invention also includes custom algorithms which may give insight prior to a click event, such as a sudden move after hesitation, which helps to avoid these situations. Nevertheless, overrides suitable to the user can be customized.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A apparatus where human gestures are interpreted by means of software running on a host computer into screen coordinates and low level commands which are in turn are sent to an actual hardware peripheral, rather than to a software based Application Programming Interface (API), which hardware corrects and polishes the said screen coordinates and low level commands and finally translates said data by means of emulating, simulating or manipulating the protocol of an actual Human Input Device (HID) which actual HID-compliant devices embedded into the invention proper, and is in turn connected back into the host computer where it is recognized by native drivers as a standard HID device so that it may thereby interact with common end-user programs in the usual manner, thus controlling the computer by means of human gestures.

2. The apparatus of claim 1, wherein the low level commands are selected from the group consisting of: a keyboard press, a click, a double-click, a drag-and-drop, and a wheel scroll.

3. The apparatus of claim 1, wherein the HID is selected from the group consisting of: a standard keyboard, a mouse, a joystick, and a touchpad.

4. The apparatus of claim 1, further comprising that said gestures, which include analog movements and analog commands and other performances of a real or virtual subject in a real world or virtual environment, respectively, are captured by means of a camera or other sensor apparatus, real or virtual, and are presented by means of a suitable interface to a front end processing device, a computer employing a central processor, memory, secondary storage media and software, or some other form of electronic or electromechanical apparatus containing stored procedures, where they are first stored as raw sensory data and then processed by means of a plurality of filters and/or interpretation or translation algorithms, the intermediate output result of which is a plurality of two dimensional X, Y and or Z movement coordinates; keyboard keystroke commands; and/or joystick directional commands; and/or mouse button click, doubleclick and wheel-scroll commands, in the form of digital codes, or other electronic signals presented as ongoing feed-forward output, or stored in an accessible table, array, queue, stack or other data structure.

5. The apparatus of claim 1, further comprising that said coordinates and commands are the processed interpretations of the said front end apparatus which is employed for its raw analysis purposes to decode or otherwise interpret the said input gestures so as to attain the said coordinates and commands which coordinates and commands being similar in terms of value to those normally gathered by an actual HID-compliant device such as a joystick, mouse, or keyboard.

6. The apparatus of claim 5, wherein the applied gestures are interpreted, filtered or otherwise translated or converted into said output coordinates and/or said output commands are indigenous to the particular gesture recognition system being employed at the time of conversion to produce said coordinates and command outputs, and the invention does not limit itself as to any specific gesture recognition method which may be employed by a person or persons skilled in the art for this purpose of producing these said intermediary outputs of coordinates and/or commands, with no claim being made here as to any specific algorithm of gesture recognition.

7. The apparatus of claim 1, further comprising that the analog movements and analog commands of said input gestures, therefore, having thus been translated into resulting digital interpretation as the resulting said digital codes, data or other electronic signals, represented as digital coordinates and commands, respectively, collected by the gesture recognition apparatus, may be stored temporarily into a buffer, a memory storage device such as RAM or other electronic or electromechanical device to hold the said coordinates and/or commands prior to utilization for some end-user purpose and end-user application making use of them.

8. The apparatus of claim 7, wherein said buffer or memory storage device is configured to contain one or more suitable data structures for this purpose of utilization.

9. The apparatus of claim 8, wherein said data structures include tables, arrays, and queues, stacks, and data structures invoking an Application Programming Interface (API).

10. The apparatus of claim 1, further comprising that the said coordinates and/or commands are applied for use by end user devices and end-user applications as follows: where obtainment of the output coordinates and/or output commands is not by means of a straight feed-forward manner such that they are first stored into said buffer on the gesture recognition side of the system, they may be first accessed and collected from said storage buffer by means of a hardware and/or software interface solution which is algorithmically designed specifically to communicate with the indigenous access protocols of the said buffer so as to facilitate the collection of the said coordinates and commands.

11. The apparatus of claim 1, further comprising that the said apparatus having interpreted said coordinates and/or commands, transfers the said coordinates and/or commands into its own memory unit buffer, structures as an arrays, queues, stacks, amongst others; the apparatus then processes said interpreted coordinates and/or commands, employing conventional filtering methods, to ultimately polish or otherwise refine in some manner the raw state of the coordinates to make them more presentable.

12. The apparatus of claim 11, wherein the filters include curve re-shaping and/or smoothing algorithms and techniques.

13. The apparatus of claim 1, further comprising that the said coordinates and/or commands, either polished as described, or raw as captured directly from the gesture recognition system by means of said capture interface, are then fed by the apparatus to an inclusive hardware based or software based emulator which invokes one or more Human Input Device (HID) compliant device interfaces so as to enter into communication with resident drivers of an end-user device running end-user application software.

14. The apparatus of claim 13, wherein the HID is selected from the group consisting of a joystick, a mouse, a keyboard.

15. The apparatus of claim 13, wherein the end-user device is selected from the group consisting of: a personal computer and a mobile computing device.

16. The apparatus of claim 1, further comprising that the final result is that the said coordinates and/or commands are captured by the apparatus, processed by the apparatus, and presented by the apparatus to the end-user device and end-user application in a manner that said end-user device and end-user application receives the coordinates and/or commands in a form indistinguishable from those of HID-compliant devices.

17. The apparatus of claim 1, further comprising that the hardware employed by the invention also provides fittings to accommodate connecting conventional HID-compliant devices to the apparatus, thereby allowing the user to override the gesture-invoked coordinates and/or commands.

18. The apparatus of claim 17, further comprising that a plurality of HID-compliant protocol devices are used by the apparatus so that it may facilitate the connection of actual HID-compliant hardware with a practically seamless integration of said override.
